(19) United States
(12) Patent Application Publication
(10) Pub. No.: US 2014/0017508 A1
(43) Pub. Date: Jan. 16, 2014

(54) INSULATING BASE PLATED WITH METAL LAYER, PLATING METHOD THEREOF, AND TRANSPARENT ELECTRODE INCLUDING INSULATING BASE

(71) Applicant: SAMSUNG ELECTRO-MECHANICS CO., LTD., Gyunngi-do (KR)

(72) Inventors: Woo Jin Lee, Gyunggi-do (KR); Da Mi Shim, Gyunggi-do (KR); Sang Ik Cho, Gyunggi-do (KR); Jung Wook Seo, Gyunggi-do (KR)

(73) Assignee: SAMSUNG ELECTRO-MECHANICS CO., LTD., Gyunggi-do (KR)

(21) Appl. No.: 13/773,576

(22) Filed: Feb. 21, 2013

(30) Foreign Application Priority Data
Jul. 16, 2012 (KR) 10-2012-0077219

(51) Int. Cl. C23C 18/30; H01B 17/16

(52) U.S. Cl. CPC C23C 18/30; H01B 17/16
USPC 428/551; 428/319.1; 427/537; 174/250

(57) ABSTRACT

Disclosed herein are an insulating base plated with a metal layer, a plating method thereof, and a transparent electrode including the insulating base. During the manufacture of a polymer layer, a structure of an interface layer between a surface of the polymer layer and a metal layer is modified, adhesion with metal is excellent and the polishability of the interface layer is reduced, and thus, the reflectivity of the metal layer is reduced and particular color impression of metal is reduced to obtain black-oxide treated properties. When the metal layer formed on the insulating base is used in a mesh-type transparent electrode having a fine pattern, sufficient adhesion with metal for forming a pattern is obtained and the reflectivity of an adhesion layer of the metal layer is reduced, thereby increasing the visibility. Accordingly, the insulating base may be suitable for products such as transparent electrodes or touch panels.

### CROSS REFERENCE TO RELATED APPLICATION

This application claims the benefit of Korean Patent Application No. 10-2012-0077219, filed on Jul. 16, 2012, entitled “Insulating Base Material Plated with Metal Layer, Plating Method Thereof, and Transparent Electrode Using the Same”, which is hereby incorporated by reference in its entirety into this application.

### BACKGROUND OF THE INVENTION

1. Technical Field

The present invention relates to an insulating base plated with a metal layer, a plating method thereof, and a transparent electrode including the insulating base.

2. Description of the Related Art

Research has been conducted on electroless plating technologies of polymer materials (e.g., polyethyleneterephthalate (PET), polyimide (PI), or the like) for many years. Various technologies are used in electroless plating technologies. As a conventional method, a base itself obtains predetermined roughness by etching a surface of the base with plasma or chemical-etching the surface of the base by using acid so as to increase a contact area, thereby increasing adhesion with metal. In addition, technologies for increasing the adhesion of a surface of an insulator have been developed by replacing catalyst in electroless plating technologies.

A method of obtaining the roughness of a surface of a base is frequently used to manufacture a printed circuit board (PCB) and is used when the line width of a circuit pattern of the PCB and the thickness of a metal layer are relatively high. However, as the roughness of a base is gradually reduced in order to embody a fine circuit, the method reduces the processability for forming relatively fine patterns, and thus, there is a limit in increasing the adhesion of a surface of a base.

In particular, in the case of a metal mesh-type electromagnetic shielding layer used in a display or a transparent electrode used in a touch screen, it is required to increase the adhesion of a metal wiring and to prevent light from being reflected off an adhesive surface of a transparent base or to reduce the visibility of the adhesive surface. However, when a method of increasing the roughness of a base to increase the adhesion is used to manufacture a display, since the optical properties of the display may deteriorate, it is difficult to use the method to manufacture the display. In this regard, research has been to widely conducted into a black-oxide treating method of reducing reflectivity and visibility of an interface with a base or a surface layer of a pattern according to a structure type.

In addition, research has also been widely conducted into a method of increasing the adhesion between a plating layer and a base by providing a functional group directly to a surface of a polymer according to a type of catalyst used in an electroless plating process.

Patent Document 1 discloses a method of manufacturing a flexible copper clad laminate, which increases the adhesion of a photosensitive resist or the like by removing regional unevenness of a surface, which is generated when metal is plated on a polymer film, to obtain the uniform roughness of the polymer film. Although the method may obtain uniform roughness of the polymer film by removing regional unevenness of the surface of the polymer film via a plasma dry treatment, the method does not obtain sufficient adhesion.

Patent Document 1 discloses a method of manufacturing a flexible copper clad laminate, which increases the adhesion of a photosensitive resist or the like by removing regional unevenness of a surface, which is generated during plating of a surface of a metal layer formed on a polymer film, to obtain the uniform roughness of the polymer film. In this case, a method of increasing the adhesion with metal to be sputtered by forming a surface of a metal seed layer via a plasma dry pretreatment prior to forming the metal seed layer is used. The method is generally used to increase the adhesion of a seed layer for electroplating. However, although the method increases the adhesion, sufficient adhesion may not be obtained or the polishability of an adhesive interface may not be reduced. In addition, Patent Document 2 also discloses a method of increasing the adhesion between a polymer material layer and a metal conductive layer by treating a polymer film with plasma and washing the polymer film to remove altered materials. The method changes roughness directly on a surface of a base and uses a sputtering method to prepare an anchor layer for plating a metal layer, and is different from the feature of the present invention of a method of forming a metal layer via electroless plating. Accordingly, although the method disclosed in Patent Document 2 increases adhesion, the method is not suitable to reduce the reflectivity of an adhesive interface.
Patent Document 1: Korean Patent Laid-Open Publication No. 2008-0076373
Patent Document 2: Japanese Patent Laid-Open Publication No. 1994-069644

### SUMMARY OF THE INVENTION

The present invention is provided as follows: unlike a conventional method, when an electroless metal plating layer is grown from an inside of a porous surface structure layer that is formed by modifying a surface of a polymer film via plasma treatment to generate a functional group to maintain the roughness of the surface and to have the amount of oxygen of 30% of more and then performing a catalyst forming process including conditioning, it is confirmed that excellent adhesion between a polymer film and a metal layer and the black-oxide treated properties of an interface between the polymer film and the metal layer are obtained.

Accordingly, the present invention has been made in an effort to provide an insulating base plated with a metal layer, which has excellent adhesion between the insulating base and a metal layer plated thereon and has a black-oxide treated interface between the insulating base and the metal layer.

Further, the present invention has been made in an effort to provide a plating method of an insulating base plated with a metal layer.

In addition, the present invention has been made in an effort to provide a mesh-type metal transparent electrode including the insulating base plated with a metal layer.

According to a first preferred embodiment of the present invention, there is provided an insulating base (hereinafter, referred to as the ‘first invention’), including: an insulating base layer; an interface layer that is formed on the insulating base, has a thickness of 40 to 80 nm and has pores with a size of 20 to 200 nm and porosity of 30 to 50%; and a metal layer plated on the interface layer.

In the first invention, the insulating base layer may have a surface arithmetic mean roughness (Ra) of 100 nm or less, the insulating base layer may be a transparent insulating base layer, and an adhesive surface between the interface layer and the metal layer may be plated with a metal layer that has a color difference value having ΔE*ab of 50 or less and C*ab of 20 or less.

In the first invention, the insulating base may include any one of polyethyleneterephthalate (PET), polyimide (PI), polycarbonate (PC), and a triacetylcellulose (TAC) film.

In the first invention, a surface of the insulating base may include acrylic primer, urethane primer, or polyvinylidenechloride primer.

In the first invention, a catalyst may be sorbed to the interface layer, the catalyst being selected from palladium (Pd), platinum (Pt), rhodium (Rh), ruthenium (Ru), silver (Ag), gold (Au), or an alloy thereof.

In the first invention, the metal layer may include copper (Cu), nickel (Ni), tin (Sn), or an alloy thereof.

According to second preferred embodiment of the present invention, there is provided a plating method (hereinafter, referred to as the ‘second invention’) of an insulating base, including: (A) performing hydrophilic plasma treatment on a surface of an insulating base to modify the surface of the insulating base so as to have 30% or more of an oxygen functional group; (B) conditioning the surface of the insulating base by processing the modified surface with a surfactant; (C) sorbing a catalyst to the insulating base by allowing the conditioned insulating base to contact a catalyst-forming liquid and then reducing the catalyst; and (D) performing electroless plating on the catalyst.

In the second invention, the insulating base may include any one of polyethyleneterephthalate (PET), polyimide (PI), polycarbonate (PC), and a triacetylcellulose (TAC) film.

In the second invention, a surface of the insulating base may include acrylic primer, urethane primer, or polyvinylidenechloride primer.

In the second invention, the plasma treatment may be performed by using oxygen (O₂) as a plasma reaction gas, and at least one selected from nitrogen (N₂), argon (Ar), and tetrafluoromethane (CF₄) as a carrier gas.

In the second invention, the surfactant may be a nonionic surfactant.

In the second invention, the nonionic surfactant may include at least one selected from the group consisting of a higher alcohol ethyleneoxide adduct, an alkyl phenol ethylene oxide adduct, a polyoxyethylene polyoxy-propylene block polymer, a polyoxyethylene polyoxy-propylene block polymer of ethylene dimamine, an ethylene oxide adduct of higher aliphatic amine, and an ethylene oxide adduct of aliphatic amide.

In the second invention, the catalyst sorbed to the surface of the base may include palladium (Pd), platinum (Pt), rhodium (Rh), ruthenium (Ru), silver (Ag), gold (Au), or an alloy thereof.

In the second invention, a metal layer formed in the electroless plating (D) may include copper (Cu), nickel (Ni), tin (Sn), or an alloy thereof.

In the second invention, an interface layer may be formed on the modified surface of the base and may have a thickness of 40 to 80 nm and have pores with a size of 20 to 200 nm and porosity of 30 to 50%.

In the second invention, the plating method may further include, after the conditioning, performing pre-dip in which the base is immersed in sulfuric acid or sulfuric acid containing anion surfactant.

In the second invention, the plating method may further include black-oxide treating a surface of the metal layer formed in the electroless plating (D) by using a black-oxide material.

According to third preferred embodiment of the present invention, there is provided a transparent electrode (hereinafter, referred to as the ‘third invention’) including the metal layer of the insulating base as set forth in any one of the first invention, which is formed on the transparent electrode to have a wiring pattern.

### BRIEF DESCRIPTION OF THE DRAWINGS

The above and other objects, features and advantages of the present invention will be more to clearly understood from the following detailed description taken in conjunction with the accompanying drawings, in which:

FIG. 1 is an image of a cross section of an insulating base according to an embodiment of the present invention;

FIG. 2 is an image (right) of a cross section of an insulating base on which plasma treatment is performed and an image (left) of a cross section of an insulating base on which plasma treatment is not performed;

FIGS. 3A and 3B are scanning electron microscope (SEM) images for showing a difference between pores formed in a surface of an insulating base on which plasma treatment is not performed and pores formed in a surface of an insulating base just after plasma treatment is performed;

FIGS. 4A and 4B are SEM images for showing the roughness of the surface of the insulating base of Example 1 after and before plasma treatment is performed on the insulating base; and

FIGS. 5A and 5B are an image of a surface of a base of a plating layer of a transparent substrate manufactured according to Comparative Example 1 and an image of a surface of a base of a plating layer of a transparent substrate manufactured according to Example 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

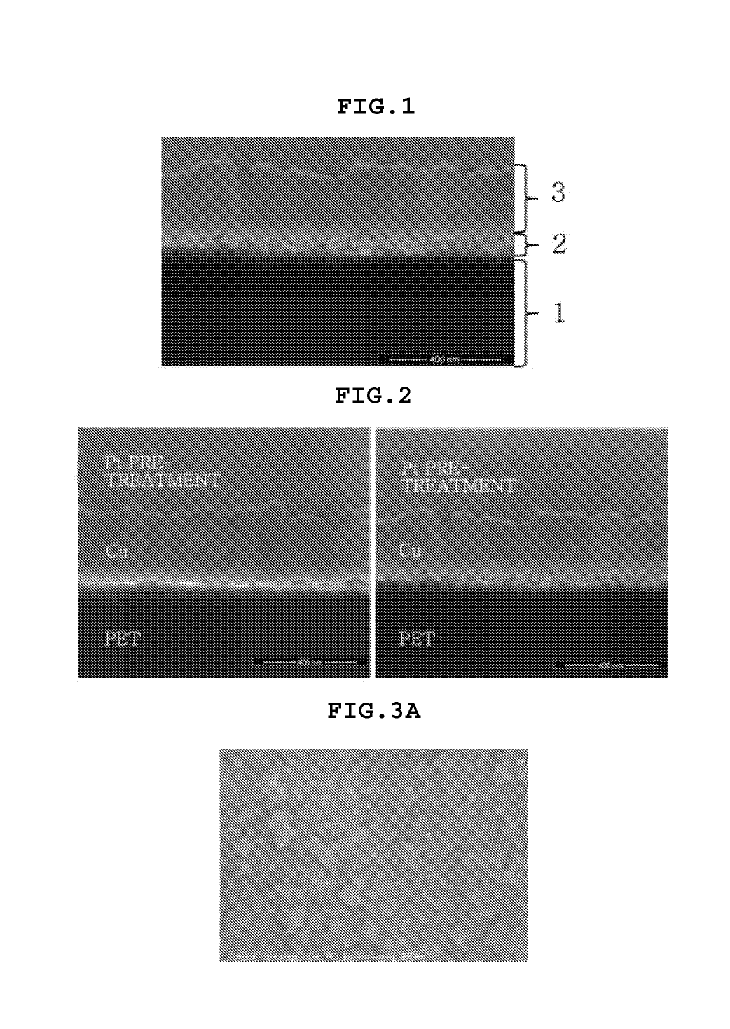

Referring to FIG. 1, an insulating base according to an embodiment of the present invention has a structure in which an interface layer 2 having a thickness of 40 to 80 nm and having pores with a size of 20 to 200 nm and porosity as a surface ratio of 30 to 50% is formed on an insulating base layer 1, and a metal layer 3 is plated on the interface layer 2. In this case, the metal layer 3 has a color difference value having ΔE*ab of 50 or less and C*ab of 20 or less, which are measured by a color meter.

The insulating base according to the present embodiment may be manufactured by (A) performing hydrophilic plasma treatment on a surface of an insulating base to modify the surface of the base so as to have 30% or more of an oxygen functional group; (B) conditioning the surface of the base by processing the modified surface with a surfactant; (C) sorbing a catalyst to the base by allowing the conditioned base to contact a catalyst-forming liquid and then reducing the catalyst; and (D) performing electroless plating on the catalyst.

Insulating Base

According to an embodiment of the present invention, the insulating base on which the metal layer (hereinafter, referred to as a “metal conductive layer”) is plated is a low roughness base having a surface arithmetic mean roughness (Ra) of 100 nm or less.

In order to maximize a black-oxide treated effect of an interface, the interface may be formed on a transparent insulating base having a surface arithmetic mean roughness (Ra) of 100 nm or less, in detail, 50 nm or less, in more detail, 10 nm or less and may be used in a metal fiber-type transparent electrode. When a surface roughness exceeds 100 nm, it is difficult to ensure sufficient adhesion for forming a metal fiber. In addition, selectively, acrylic primer, urethane primer, or polyvinylidenechloride-based primer is coated on a surface of the insulating base to maintain the surface arithmetic mean roughness (Ra) of 100 nm or less.

For example, the insulating base may be, but is not limited to, polyethyleneterephthalate (PET), polycarbonate (PC), polymethyl methacrylate (PMMA), polyethylene naphthalate (PEN), polyether sulfone (PES), a ring-like olefin polymer (COC), a triacetylcellulose (TAC) film, a polyvinyl alcohol (PVA) film, a polyimide (PI) film, polystyrene (PS), biaxially oriented polystyrene (BOPS), or the like. In more detail, the insulating base may be PET, PI, PC, a TAC film, or the like.

A surface of the insulating base is treated with plasma to activate the surface of the insulating base, thereby increasing the adhesion between the insulating base and a metal layer to be plated.

(A) Modifying Surface of Base Via Plasma Treatment

According to an embodiment of the present invention, plasma treatment may be performed via an atmosphere or vacuum plasma method. In the modifying of the surface of the base via plasma treatment in order to form the metal layer, the plasma treatment may be used by using oxygen (O₂) as a plasma reaction gas and at least one of nitrogen (N₂), argon (Ar) and tetrafluoromethane (CF₄) as a carrier gas.

When oxygen (O₂) is used as a plasma reaction gas, radical oxygen debond hydrogen bonding of polymer of the insulating base to generate a hydrophilic functional group such as a carboxyl group, a hydroxyl group, or the like. In general plasma treatment, smear is oxidation-decomposed from a surface that is subject to the plasma treatment by allowing plasma to contact the surface, and simultaneously, a material of a surface of a base is appropriately removed to roughen the surface.

However, according to the present embodiment, a hydrophilic functional group such as a hydroxyl group or the like may be generated via plasma treatment. Whether the hydrophilic functional group is generated may be confirmed according to the amount of increased atomic oxygen (refer to X-ray photoelectron spectroscopy (XPS) componential analysis in Table 3 below). According to the present embodiment, it is required to modify the surface of the base to include an oxygen functional group of 30% or more. In this case, when the amount of oxygen functional group is less than 30%, it is difficult to form desired level of pores on a surface in which visualized pores are formed after a catalyst layer is formed. A plasma treatment apparatus according to an embodiment of the present invention may be, for example, PCB2800E available from March Plasma Systems. Examples of detailed operations and operational conditions of plasma treatment are described as follows.

[Condition of Plasma Treatment]

Gas: CF₄/O₂/N₂, CF₄/O₂/Ar, N₂/O₂, or Ar/O₂

Ambient pressure: 10 to 500 mTorr

Output: 500 W to 10,000 W

Time: 60 to 600 seconds

(B) Conditioning

According to an embodiment of the present invention, the surfactant used in the conditioning may be an anion surfactant, a cation surfactant, and/or a nonionic surfactant, in more detail, a nonionic surfactant. Examples of the nonionic surfactant may include a higher alcohol ethyleneoxide adduct, an alkyl phenol ethylene oxide adduct, a polyoxyethylene polyoxy-propylene block polymer, a polyoxyethylene polyoxy-propylene block polymer of ethylene diamine, an ethylene oxide adduct of higher aliphatic amine, an ethylene oxide adduct of aliphatic amide, or the like. In more detail, examples of the nonionic surfactant may include a higher alcohol ethyleneoxide adduct, an alkyl phenol ethylene oxide adduct, a polyoxyethylene polyoxy-propylene block polymer, or the like.

When the nonionic surfactant is used as the surfactant, a concentration of the nonionic surfactant may be 0.1 to 200 g/l, in more detail, 0.5 to 10 g/l. When the concentration is less than 0.1 g/l, desired wettability may not be obtained. When the concentration exceeds 200 g/l, a photoresist may peel off and economic feasibility may be reduced. By adjusting a time taken to perform the conditioning, desired pores may be formed after the catalyst is reduced. In detail, the conditioning may be performed for six minutes or less.

Pre-Dip Treatment

According to an embodiment of the present invention, selectively, pre-dip treatment may be performed on the conditioned base by immersing the conditioned base in sulfuric acid having almost the same concentration as the catalyst-forming liquid prior to sorption of the catalyst. The pre-dip treatment is performed in order to create the hydrophilic property of the surface of the base to increase the sorptive property with respect to catalyst ions (e.g., palladium (Pd) ions) contained in the catalyst-forming liquid, to repeatedly reuse the catalyst-forming liquid by preventing washing water used in previous processes from being mixed with the catalyst-forming liquid, or to remove an oxidation layer. Generally, a pre-dip liquid may be sulfuric acid or sulfuric acid containing anion surfactant. In order to perform pre-dip treatment, the base is immersed in the pre-dip liquid. In addition, washing is not performed after the pre-dip treatment is performed.

(C) Sorbing of Catalyst

In (C) sorbing of the catalyst, the catalyst sorbed to the surface of the insulating base may be a solution containing metal palladium (Pd), platinum (Pt), rhodium (Rh), ruthenium (Ru), silver (Ag), or gold (Au), in more detail, Pd. Examples of the solution may include water, an organic solvent, an organic mixed solvent, or a mixed solvent of organic solvent and water, in more detail, water. When the solution includes water, the catalyst is inexpensive and is easily treated. For example, by allowing an acid liquid containing Pd²⁺ ions to contact the surface of the insulating base, Pd²⁺ ions are substituted with metal Pd on the surface of the base according to ionization tendency (Cu+Pd²⁺→Cu²⁺+Pd). The catalyst (e.g., Pd) sorbed to the surface of the base functions as a catalyst for electroless plating. A Pd salt that is a source of Pd²⁺ ions may be palladium sulfate or palladium chloride. Since the sorption capacity of palladium sulfate is lower than that of palladium chloride, and Pd is easily removed from palladium sulfate, palladium sulfate is suitable for forming a micro line.

Palladium sulfate-based catalyst-forming liquid, which is effective for copper (Cu), may be a strong acid liquid (e.g., KAT-450 available from Uyemura & Co., Ltd.) including sulfuric acid, Pd salt, and Cu salt or a strong acid liquid (MNK-4 available from Uyemura & Co., Ltd.) including oxycarboxylic acid, sulfuric acid, and Pd salt. Since the sorption capacity and substitution properties of palladium chloride are high, and it is difficult to remove Pd from palladium chloride, when electroless plating is performed at a condition where plating peeling occurs easily, plating peeling may be prevented from occurring. A process of forming a Pd catalyst is performed by allowing the base to contact the catalyst-forming liquid via an immersion method, a spraying method, or the like and then washing the base.

A chelating agent may be generally used to remove impurities. The chelating agent may be absorbed into a surface of a particle, may limit growth of the particle, and may limit aggregation based on a steric hindrance effect, thereby obtaining the stability of a suspension. Examples of the chelating agent may include 2-pyridylamine, polyvinyl alcohol (PVA), polyvinyl pyrrolidone (PVP), sodium lauryl sulfate (SLS), Dodecylbenzene sulfonic acid sodium salt (SDBD), cetyltrimethylammonium bromide (CTAB), tetraoctylammonium bromide (TOAB), polyethylene glycol (PEG), ethylenediaminetetraacetic acid (EDTA), starch, β-cyclodextrin (β-CD), or the like. In detail, the chelating agent may be 2-pyridylamine. A ratio of metal to the chelating agent may be 1 to 10, in detail, 2 to 6.

Then, the base is immersed in a reduction solution via a general method. For example, the reduction solution includes dimethylamineborane (DMAB), and reduction is performed for one to ten minutes.

(D) Electroless Plating

According to an embodiment of the present invention, the metal layer formed in (D) electroless plating may be formed by performing electroless Cu, Ni, or NI/Cu plating. An electroless Ni plating bath may be a plating bath including, for example, a water-soluble Ni salt, a reducing agent, and a complexing agent. The water-soluble nickel (Ni) salt may be, for example, Ni sulfate, Ni chloride, or the like and may have a concentration of 0.01 to 1 mol/l. The reducing agent may be, for example, hypophosphorous acid, a hypophosphorous acid salt such as sodium hypophosphite or the like, dimethylamine borane, trimethyl amine borane, hydrazine, or the like and may have a concentration of 0.01 to 1 mol/l. The complexing agent may be, for example, carboxylic acid such as malic acid, succinic acid, lactic acid, or citric acid, or sodium salt thereof, or amino acids such as glycine, alanine, iminodiacetic acid, arginine, or glutamine acid and may have a concentration of 0.01 to 2 mol/l. The electroless Ni plating bath is adjusted to have a pH of 4 to 7 and is used at a temperature of 40 to 90° C. When hypophosphorous acid is used as a reducing agent in the electroless Ni plating bath, a major reaction occurs on the surface of the base according to Reaction Scheme 1 below to form a Ni plating membrane.

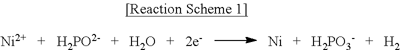

An electroless Cu plating bath may be a plating bath including, for example, a water-soluble Cu salt, a reducing agent, and a complexing agent. The water-soluble Cu salt may be, for example, Cu sulfate, Cu chloride, or the like and may have a concentration of 0.01 to 1 mol/l. The reducing agent may be, for example, hypophosphorous acid, a hypophosphorous acid salt such as sodium hypophosphite or the like, dimethylamine borane, trimethyl amine borane, hydrazine, or the like and may have a concentration of 0.01 to 1 mol/l. The complexing agent may be, for example, ethylenediamine-4-acetic acid, tartaric acid, or the like. A concentration of the complexing agent in an electroless Cu plating liquid may be 0.02 to 0.5 mol/l. According to the present embodiment, the electroless Cu plating liquid may have a pH of 10 to 14, in more detail, 12 to 13. The electroless Cu plating liquid may be used at a plating bath temperature of 40 to 90° C. in order to obtain the stability of the electroless Cu plating bath and to satisfy of a precipitation speed of Cu. Since formalin adversely affects the human body and the environment, glyoxylic acid instead of formalin may be used as the reducing agent of the electroless Cu plating bath. A concentration of the glyoxylic acid in the electroless Cu plating liquid may be 0.005 to 0.5 mol/l, in more detail, 0.01 to 0.2 mol/l. When the concentration of the glyoxylic acid is less than 0.005 mol/l, a plating reaction does not occur. When the concentration of the glyoxylic acid exceeds 0.5 mol/l, the electroless Cu plating liquid becomes unstable and is decomposed. When hypophosphorous acid is used as the reducing agent of the electroless Cu plating bath, a major reaction occurs on the surface of the base according to Reaction Scheme 2 below to form a Cu plating membrane.

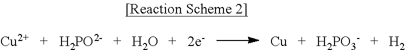

A pH adjuster may be a generally-used material, for example, sodium hydroxide, potassium hydroxide, or the like. However, in order to avoid using alkali metal such as sodium, potassium, or the like, when the pH adjuster is used in a semiconductor, tetramethylammonium hydroxide may be used.

According to the present embodiment, selectively, a surface of the metal layer formed in (D) electroless plating may be black-oxide treated by using a black-oxide material. The black-oxide treatment is performed in order to prevent light from being reflected when both of the two surfaces of the base is plated with a metal layer to form a metal layer. A black-oxide treating method may be appropriately selected from among various black-oxide treating methods that are well known to one of ordinary skill in the art to which the present invention pertains.

Porosity and Black-Oxide Treating

According to an embodiment of the present invention, with regard to the insulating base on which the metal layer is formed, after a catalyst is sorbed to a surface of the insulating base, an interface layer may be formed on the surface of the insulating layer. In this case, the interface layer may have pores with a size of 20 to 200 nm and may have a thickness of 40 to 80 nm. In addition, the interface layer may have porosity of 30 to 50% in order to maximize the adhesion with metal to be plated and a black-oxide treated effect. For example, when the interface layer satisfies these ranges of sizes and porosity of pores, a color difference value having ΔE*ab of 50 or less and C*ab of 20 or less may be obtained, thereby reducing the reflectivity of the metal layer and reducing particular color impression of metal to exhibit dark color.

Referring to FIG. 1, according to whether plasma treatment is performed, pores are formed or not formed in the interface layer 2. If plasma treatment is not performed or is performed by using a different method from the present invention, fine pores are not formed in the interface layer 2 or porosity of pores is low. Thus, after plating is performed, sufficient adhesion with metal is not obtained and an interface layer having reduced reflectivity is not formed. On the other hand, when plasma treatment is performed at appropriate conditions, fine pores are formed in the interface layer 2, thereby obtaining increased adhesion with metal.

According to an embodiment of the present invention, after the plasma treatment is performed, pores may be formed by adjusting a conditioning time in the conditioning via a surfactant. That is, a hydrophilic functional group is generated via the plasma treatment and then the conditioning is performed via a nonionic surfactant to form the pores. The conditioning may be performed for 6 minutes or less to form the pores in the interface layer and to black-oxide treat the interface layer. Black-oxide treated properties may be confirmed in that an interface layer looks dark when metal (Cu or Ni) of a nanoparticle size that is sorbed to the interface layer according to shapes of pores formed in the interface layer to form a metal layer.

A transparent electrode may be formed by forming a plating layer on an insulating base and then etching the plating layer or removing the plating layer via a laser beam to pattern the plating layer. Thus, a transparent electrode including the plating layer in which a wiring pattern is formed via an etching method, according to an embodiment of the present invention may be manufactured. In addition, a touch panel including the transparent electrode may be manufactured. In addition, the transparent electrode according to the present embodiment may have a single layer structure and may be used in a self capacitive type touch panel, a mutual capacitive type touch panel, or the like.

Hereinafter, one or more embodiments of the present invention will be described in detail with reference to the following examples. However, these examples are not intended to limit the purpose and scope of the one or more embodiments of the present invention.

### Example 1

Plasma treatment was performed on a polyethylene terephthalate (PET) film having a size of 30 cm×30 cm by using an atmospheric pressure plasma apparatus under a condition of 20 l of argon gas and 80 ml of oxygen to hydrophilize a surface of the PET film. The PET film having the modified surface was immersed in a solution including 2% of Triton X-100 and 2% of guanidinium ions as a nonionic surfactant for about six minutes. The processed PET film was immersed in a solution including Pd ions (Pd²⁺) as a catalyst and 2-pyridylamine as a chelating agent for five minutes. Then, the PET film was immersed in a reduction solution including dimethylamineborane (DMAB) for five minutes to reduce the sorbed Pd catalyst. Then, washing was performed on the resultant and then plating was performed in a Cu plating solution including cupric sulfate as a reducing agent at a temperature of about 34° C. for about 20 minutes.

### Comparative Example 1

Plating was performed in the same manner as in Example 1 except that plasma treatment was not performed on a PET film having a size of 30 cm×30 cm PET.

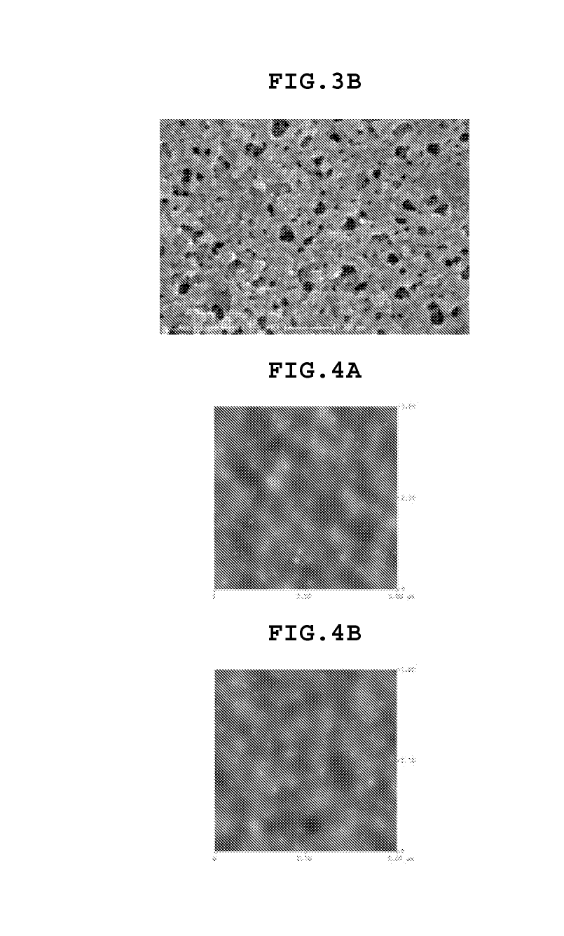

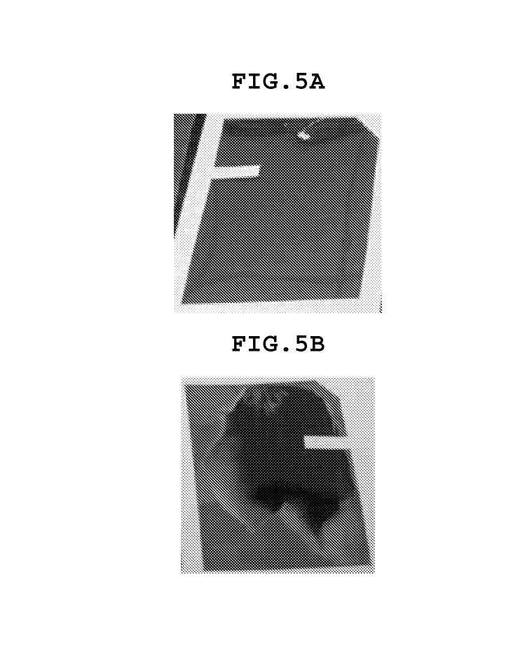

FIG. 2 is an image of cross sections of insulating bases plated with a metal layer according to Example 1 and Comparative 1. FIGS. 3A and 3B are images for showing a difference between pores formed in the surfaces of the insulating bases of Example 1 and Comparative 1. FIGS. 4A and 4B are images for showing the roughness of the surface of the insulating base of Example 1 before and after plasma treatment is performed on the insulating base. As shown in FIGS. 2 through 3B, it may be confirmed that pores having a size of several tens to 200 nm and porosity of 20 to 50% are formed in the surface of the insulating base of Example 1 from the cross section of the insulating base. As shown in FIGS. 4A and 4B, it is confirmed that the roughness of the surface of the insulating base of Example 1 is not substantially changed before and after plasma treatment is performed (roughness prior to plasma treatment: 3.93 nm, and roughness after plasma treatment: 3.64 nm). Thus, it is confirmed that the surface of the insulating base shown in FIG. 3 is not caused by a roughness change due to reactive plasma surface treatment.

Color difference values of the insulating base plated with a metal layer according to Example 1 and Comparative Example 1 are measured by a color meter and are shown in Table 1 below.

TABLE 1

| Division | L* | a* | b* | ΔE*ab | C*ab |
|---|---|---|---|---|---|
| Example 1 | 31.62 | 6.12 | 5.49 | 32.58 | 8.22 |
| Comparative | 76.42 | 17.27 | 21.13 | 81.06 | 27.29 |
| Example 1 | | | | | |

As shown in Table 1, in Example 1, all L*, a*, and b* are reduced, a C*ab color difference value is also reduced by 50% or more, and an entire ΔE*ab color difference value is also reduced by 50% or more, compared with Comparative Example 1.

From Table 2 below, the adhesions of the PET films manufactured in Example 1 and Comparative Example 1 are confirmed. In this end, 3M adhesive tape was adhered to a test piece having a width of 10 cm by as much as pattern widths shown in Table 2 below and then was removed. In this case, whether a pattern peeled was confirmed from a portion of the pattern, which applies the 3M adhesive tapes, or from a change in resistance after the pattern is formed.

TABLE 2

| Whether pattern | | | |
|---|---|---|---|
| is peeled by tape | Width of 10 | Width of | Width of |
| according to pattern width | cm or more | 40 μm | 10 μm or less |
| Example 1 | ◯ | ◯ | ◯ |
| Comparative Example 1 | X | X | X |

◯: Not Peeled,
X: Peeled

Although a pattern having a pattern width of 10 gill or less is formed in a plating metal layer formed according to Example 1, it is confirmed that the pattern does not peel due to the adhesive tape.

As shown in FIGS. 3A and 3B, since plating is also performed inside pores of a size of several tens of nm, which is formed in the surface of the insulating base, excellent adhesion and black-oxide treated effect are exhibited.

Results of X-ray photoelectron spectroscopy (XPS) componential analysis after and before plasma treatment is performed on the insulating base according to Example 1 are shown in Table 3 below.

TABLE 3
Results of XPS componential analysis

| Division | C1s | O1s |
|---|---|---|
| Prior to plasma treatment | 77.11 | 19.69 |
| After plasma treatment | 65.63 | 30.02 |

It is confirmed that a hydrophilic functional group is generated after plasma treatment was performed, since a ratio of atomic oxygen to an entire material of the modified surface of the insulating base is increased from 19.69 to 30.02.

According to the preferred embodiments of the present invention, during manufacture of a polymer layer, a structure of an interface layer between a surface of the polymer layer and a metal layer is modified, adhesion with metal is excellent and the polishability of the interface layer is reduced to obtain black-oxide treated properties. When the polymer film is formed on a transparent substrate, metal may prevent light from being reflected off an insulating base plated with the metal, thereby increasing the visibility. Accordingly, the insulating base may be suitable for products such as transparent electrodes or touch panels.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An insulating base, comprising:
an insulating base layer;
an interface layer that is formed on the insulating base layer, has a thickness of 40 to 80 nm and has pores with a size of 20 to 200 nm and porosity of 30 to 50%; and
a metal layer plated on the interface layer.

2. The insulating base as set forth in claim 1, wherein the insulating base layer has a surface arithmetic mean roughness (Ra) of 100 nm or less.

3. The insulating base as set forth in claim 1, wherein the insulating base layer is a transparent insulating base layer, and
wherein an adhesive surface between the interface layer and the metal layer is plated with a metal layer that has a color difference value having ΔE*ab of 50 or less and C*ab of 20 or less.

4. The insulating base as set forth in claim 1, wherein the insulating base includes any one of polyethyleneterephthalate (PET), polyimide (PI), polycarbonate (PC), and a triacetylcellulose (TAC) film.

5. The insulating base as set forth in claim 1, wherein a surface of the insulating base includes acrylic primer, urethane primer, or polyvinylidenechloride primer.

6. The insulating base as set forth in claim 1, wherein a catalyst is sorbed to the interface layer, the catalyst being selected from palladium (Pd), platinum (Pt), rhodium (Rh), ruthenium (Ru), silver (Ag), gold (Au), or an alloy thereof.

7. The insulating base as set forth in claim 1, wherein the metal layer includes copper (Cu), nickel (Ni), tin (Sn), or an alloy thereof.

8. A plating method of an insulating base, comprising:
(A) performing hydrophilic plasma treatment on a surface of an insulating base to modify the surface of the insulating base so as to have 30% or more of an oxygen functional group;
(B) conditioning the surface of the insulating base by processing the modified surface with a surfactant;
(C) sorbing a catalyst to the insulating base by allowing the conditioned insulating base to contact a catalyst-forming liquid and then reducing the catalyst; and
(D) performing electroless plating on the catalyst.

9. The plating method as set forth in claim 8, wherein the insulating base includes any one of polyethyleneterephthalate (PET), polyimide (PI), polycarbonate (PC), and a triacetylcellulose (TAC) film.

10. The plating method as set forth in claim 9, wherein a surface of the insulating base includes acrylic primer, urethane primer, or polyvinylidenechloride-based primer.

11. The plating method as set forth in claim 8, wherein the plasma treatment is performed by using oxygen (O₂) as a plasma reaction gas, and at least one selected from nitrogen (N₂), argon (Ar) and tetrafluoromethane (CF₄) as a carrier gas.

12. The plating method as set forth in claim 8, wherein the surfactant is a nonionic surfactant.

13. The plating method as set forth in claim 12, wherein the nonionic surfactant includes at least one selected from the group consisting of a higher alcohol ethyleneoxide adduct, an alkyl phenol ethylene oxide adduct, a polyoxyethylene polyoxy-propylene block polymer, a polyoxyethylene polyoxy-propylene block polymer of ethylene dimamine, an ethylene oxide adduct of higher aliphatic amine, and an ethylene oxide adduct of aliphatic amide.

14. The plating method as set forth in claim 8, wherein the catalyst sorbed to the surface of the base includes palladium (Pd), platinum (Pt), rhodium (Rh), ruthenium (Ru), silver (Ag), gold (Au), or an alloy thereof.

15. The plating method as set forth in claim 8, wherein a metal layer formed in the electroless plating (D) includes copper (Cu), nickel (Ni), tin (Sn), or an alloy thereof.

16. The plating method as set forth in claim 8, wherein an interface layer is formed on the modified surface of the base, and has a thickness of 40 to 80 nm and has pores with a size of 20 to 200 nm and porosity of 30 to 50%.

17. The plating method as set forth in claim 8, further comprising:
after the conditioning, performing pre-dip in which the base is immersed in sulfuric acid or sulfuric acid containing anion surfactant.

18. The plating method as set forth in claim 8, further comprising black-oxide treating a surface of the metal layer formed in the electroless plating (D) by using a black-oxide material.

19. A transparent electrode including the metal layer of the insulating base as set forth in claim 1, which is formed on the transparent electrode to have a wiring pattern.
